(19) United States
(12) Patent Application Publication
(10) Pub. No.: US 2003/0197968 A1
(43) Pub. Date: Oct. 23, 2003

(54) Bi-directional servo track writing to minimize sidewall writing at high skew angles

(76) Inventors: Alexei Hiram Sacks, Edina, MN (US); Haoying Sun, Miami, FL (US)

Correspondence Address: David K. Lucente, Seagate Technology LLC, Intellectual Property - COL2LGL, 389 Disc Drive, Longmont, CO, 80503, US

(21) Appl. No.: 10/262,830

(22) Filed: Oct. 2, 2002

Related U.S. Application Data
(60) Provisional application No. 60/374,082, filed on Apr. 18, 2002.

(51) Int. Cl. G11B 21/02; G11B 20/20

(52) U.S. Cl. 360/75; 360/76

(57) ABSTRACT

Head skew can cause magnetic transition overlap while writing at least two passes for a data track. That overlap can cause interference, which may affect the position error signal and other portions of the servo sector, such as sector address mark and digital data, of the servo system of the disc drive. The present invention overcomes this problem by utilizing a bi-directional servo writing method. One method of the present invention writes the servo information to the MD from either direction. More particularly, this method writes servo information from the OD to the MD and from the ID to the MD. In this manner, the present invention at least reduces the effects of head skew while writing servo information.

### CROSS-REFERENCE TO RELATED APPLICATIONS

This application claims priority from U.S. Provisional Application No. 60/374,082 filed on Apr. 19, 2002, entitled BI-DIRECTIONAL STW TO MINIMIZE SIDEWALL WRITING AT HIGH SKEW ANGLES.

### FIELD OF THE INVENTION

The present invention relates generally to disc drives. In particular, the present invention relates to servo track writing.

### BACKGROUND OF THE INVENTION

The typical disc drive in a computer has at least one disc that stores information. Referring to FIG. 1, a disc 100 is shown that has an associated actuator 110. At the distal end of actuator 110 is a head 120. The information is written and read in concentric tracks—one is designated 130—on the disc by head 120. The disc drive then must be able to follow each data track to read and write the information. To assist in such data track follow, servo information is written on each data track at intervals. The servo information is used by the disc drive to, among other things, keep the head aligned with the desired data track. The servo information is typically written prior to writing information to the disc.

Due to the structure of the disc drive, the head azimuth usually has a non-zero azimuth angle with respect to the data track where the servo information is written. This is known as skew. Also due to that structure, the skew changes as the head moves between the inner diameter (ID) and outer diameter (OD). At some point between the ID and OD, the head skew transitions between positive and negative.

### SUMMARY OF THE INVENTION

Head skew can cause poor magnetic transition overlap while writing a servo track. That overlap can cause interference, which may affect the position error signal of the servo system of the disc drive. The present invention overcomes this problem by utilizing a bi-directional servo writing method. One method of the present invention writes the servo information to approximately a middle diameter (MD) from either direction. More particularly, this method writes servo information from the OD to approximately the MD and from the ID to approximately the MD. In this manner, the present invention reduces the effects of the head skew while writing servo information.

In more detail, the present invention predetermines the MD that can be based on the geometry of the disc and the corresponding estimated radial distance where the head skew transitions from positive to negative. With that predetermined MD, the present invention writes from the OD to just pass the MD, then writes from the ID to just past the MD. The radial distance where the ID writing ends generally defines a zone where there are no data tracks written or a magnetic interference region exists between some of the OD and ID written data tracks. Preferred guard bands are disposed on either side of this zone to define a reserved zone. This reserved zone separates the OD and ID written zones.

A further method of the present invention provides for writing data track identification to each data track. In one variation of this method, all the data tracks are written from the OD to the ID. This will provide how many data tracks can be written to the disc surface. Then a portion of the written data tracks are rewritten from the ID to some MD, using the data track numbering previously determined. An alternative variation of this method defines zones, such as the OD to MD zone and the ID to MD zone. Each zone is then given an identifier, such as an additional bit stored in the servo information. The data tracks are numbered relative to their associated zone.

These and various other features as well as advantages which characterize the present invention will be apparent upon reading of the following detailed description and review of the associated drawings.

### BRIEF DESCRIPTION OF THE DRAWINGS

FIG. 1 shows a disc and associated actuator track following a data track on the disc.

FIG. 2 shows undesired magnetic transition overwriting caused by head skew.

FIGS. 3A-3C generally shows stitching of servo information.

FIG. 4 shows writing servo information in one direction taking into account head skew according to the present invention.

FIG. 5 shows undesired magnetic transition overwriting caused by head skew in the other direction.

FIG. 6 shows writing servo information in another direction from FIG. 4 taking into account head skew according to the present invention.

FIGS. 7A-7B show a MFM of servo patterns written with and without the present invention.

FIG. 8 is a graph showing the effects of skew on a position error signal.

FIG. 9 illustrates a bi-directional servo writing of the present invention.

FIG. 10 illustrates a preferred embodiment of the bi-directional servo writing of the present invention.

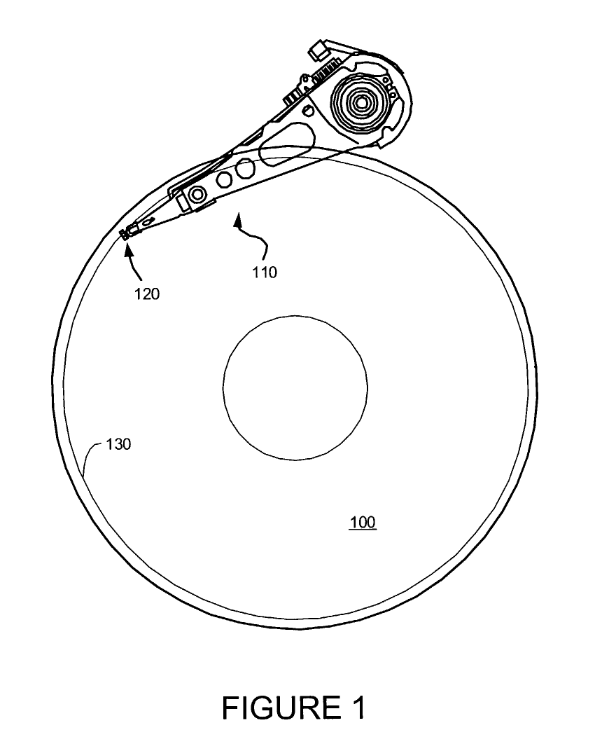

### DETAILED DESCRIPTION OF ILLUSTRATIVE EMBODIMENTS

While this invention is susceptible of embodiment in many different forms, there is shown in the drawings and will be described herein in detail specific embodiments thereof with the understanding that the present disclosure is to be considered as an exemplification of the principles of the invention and is not to be limited to the specific embodiments described.

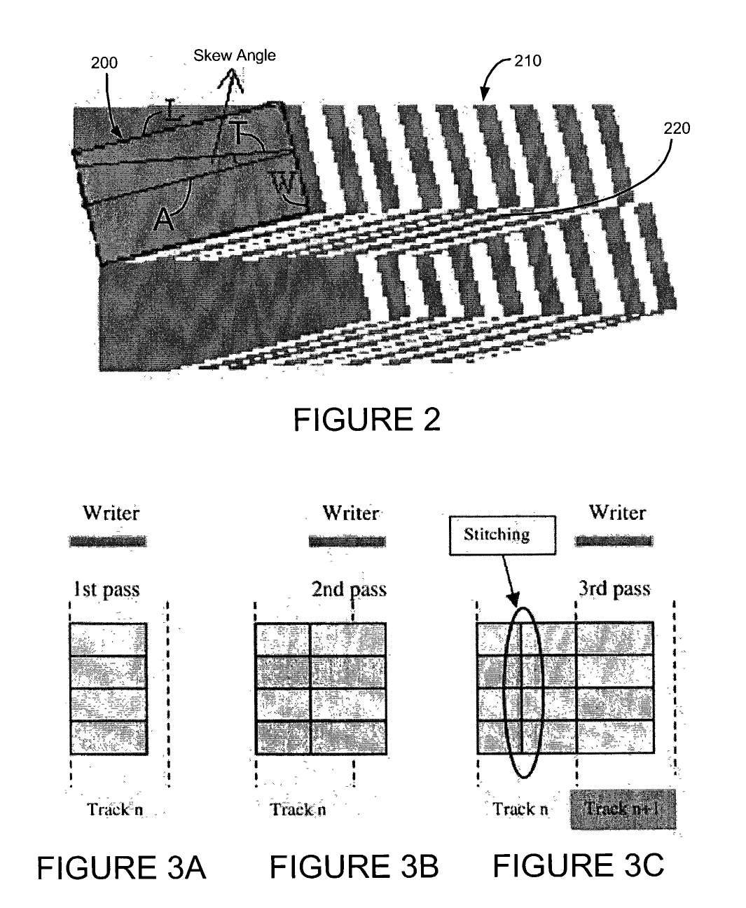

An issue with head skew is that it causes unwanted overwriting of previously written servo information. In general, the skew causes not only the magnetic flux from the leading edge of the writer to create magnetic transitions on the disc, but also the magnetic flux of the sidewall edge of the writer to create magnetic transitions on the disc. In particular, for longitudinal recording, a writer tip of the head is rectangular. Referring to FIG. 2, a writer tip 200 has a leading edge W, a sidewall edge L and a longitudinal axis A. The leading edge W of the trailing pole of the writer 200 writes magnetic transitions 210 on the disc. A line T represents the center of the servo track portion that is being written. Line T is tangent to the radial position at that point. The angle between line T and axis A defines the skew angle. The effect of the sidewall edge L—shown by 220—is proportional to the skew angle and the dimension of the sidewall edge L. In perpendicular recording, the writer tip of the head has a square footprint, i.e. the sidewall edge is shorter than that of the longitudinal writer sidewall edge L. This writer dimension change combined with the properties of perpendicular recording makes the undesired sidewall writing more severe in perpendicular recording.

The sidewall writing described above is detrimental to the servo tracks. When servo tracks are written, at least two writing passes are typically used to write one data track. The stitching between two writing passes is very vulnerable to the sidewall writing. FIGS. 3A-C demonstrate the servo track writing (STW) process and the stitching. In FIG. 3A, a first pass for servo track writing on data track n is performed. In FIG. 3B, a second pass for servo track writing on data track n is performed. FIG. 3C shows a third pass, which is the start of servo track writing for data track n+1. The stitching shown in FIG. 3C shows how the first two passes (for data track n) abut.

However, typical disc drives have positive skew angles from the OD to about some middle diameter (MD), negative skew angles from about the MD to the ID. When the skew angle changes at about the MD location from positive to negative angles, undesired writing of the sidewall also changes to the other sidewall of the writer tip.

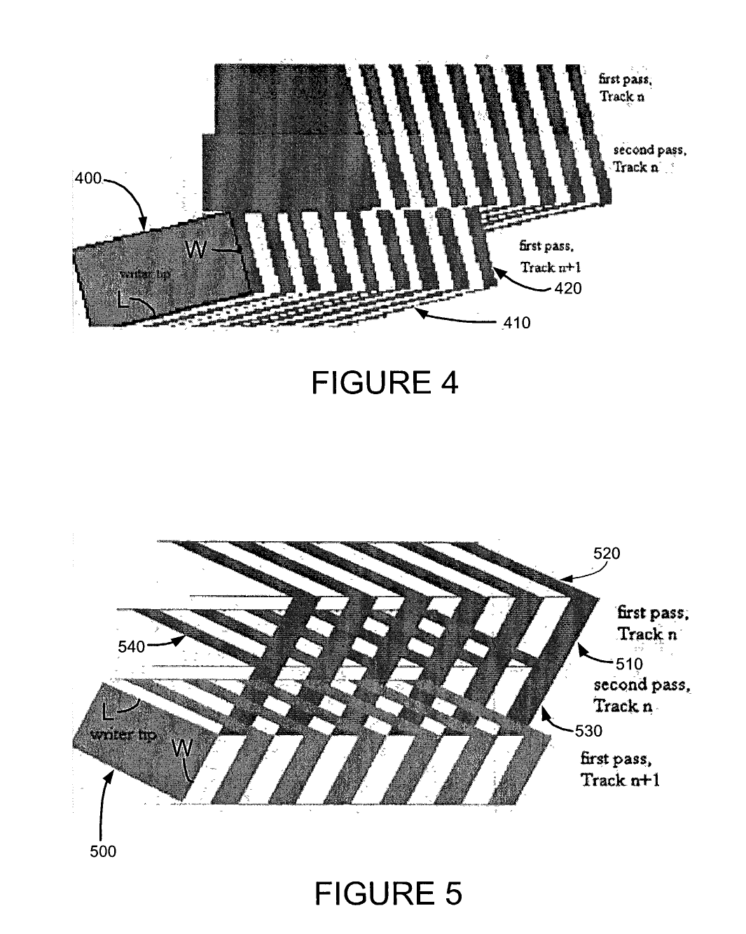

Traditional STW techniques write servo tracks in one direction, usually starting at the OD first, then moving toward the ID to write the following servo tracks. In the positive skew region (from OD to MD), the writer's sidewall writes transitions on one side while the leading edge of the writer writes good transitions on the first pass. This phenomenon is shown in FIG. 4. The first pass of data track n is written by a writer tip 400, which has leading edge W and sidewall edge L. Although blocked by the shown second pass for data track n, the first pass for data track n causes magnetic transitions in the disc similar to the magnetic transitions 410 of the first pass for data track n+1. Note that the sidewall edge L causes transitions 410 that extend at an angle from transitions 420 caused by the leading edge W of the writer tip 400. Then at the second pass, the leading edge writes good transitions on top of the transitions previously created by the sidewall edge L from the first pass. Thus, there is no undesired transition band being left on the media between the passes for the servo track. The stitching between the passes for data track n is as desired.

In the negative skew region (from MD to ID), the writer writes good transitions on the first pass, then at the second pass starts to write undesired transitions on top of the good transition written in the first pass. Referring to FIG. 5, a writer tip 500 uses a leading edge W to write magnetic transitions 510 during a first pass of servo writing for data track n. A sidewall edge L also writes magnetic transitions 520 during that same pass. Upon the second pass of servo writing for data track n, the leading edge W writes magnetic transitions 530. Yet the sidewall edge L also writes magnetic transitions 540 during that second pass. Magnetic transitions 540, unfortunately, overwrite or interfere with the previous written magnetic transitions 510 of the first pass. Likewise, the first pass of the servo writing for data track n+1 overwrites or interferes with the previously written magnetic transitions 530 of the second pass for data track n. Thus, undesired transition bands are left in the middle of a data track and between data tracks.

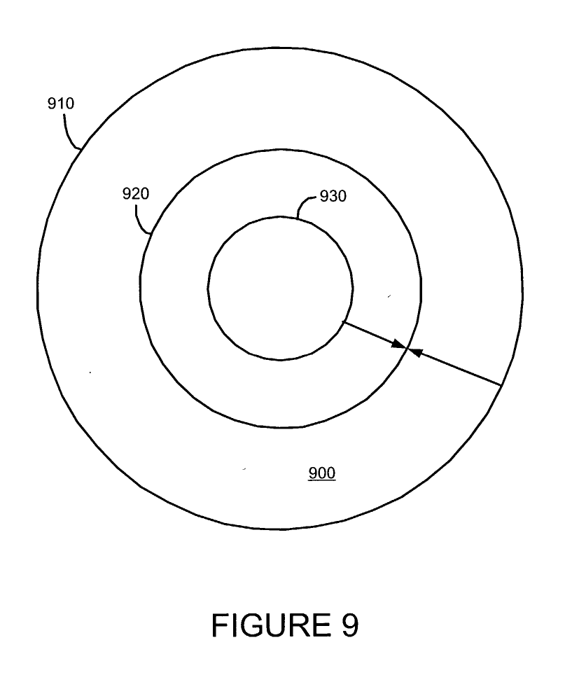

To overcome this undesired effect caused by the writer skew, the present invention writes the servo information from the OD to about some MD position and then from the ID to about that MD position. In other words, the servo information is written toward the MD from either direction. Referring to FIG. 9, a disc 900 has an OD 910, some MD position 920 and an ID 930. The present invention writes the servo information toward MD 920. For example, the servo information is written from OD 910 to MD 920, and from ID 930 to MD 920 as shown by the arrows. The MD preferably is picked to at least minimize the head skew. The determination of the MD position can be based on other criteria, such as the geometry of the disc, servo error generation or an arbitrary criterion.

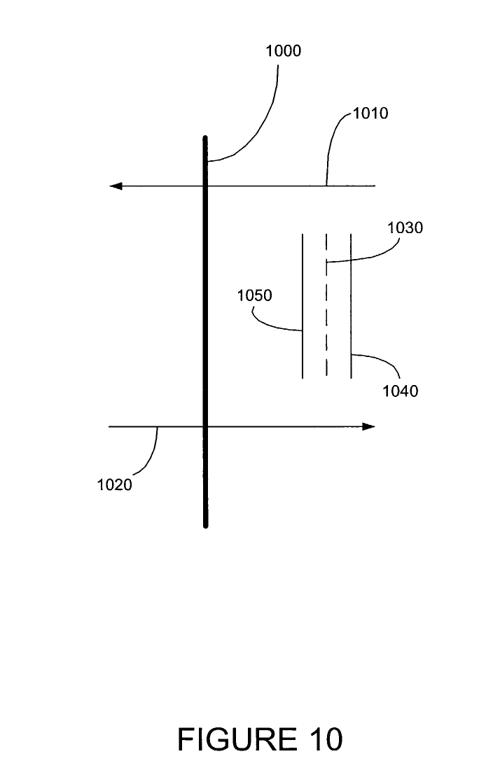

Referring to FIG. 10 for more detail, a predetermined MD position is signified by reference number 1000. The present invention writes data from the OD past MD position 1000 in the direction shown by arrow 1010. Then servo information is written from the ID past MD position 1000 in the direction shown by arrow 1020. In particular, the present invention can write from the OD to just past the MD, such as MD+Δ, then write from the ID to just past MD, say MD+ε, where Δ may equal ε. The symbols A and E represent at least one data track each. Where the ID writing ends, a region represented by dashed line 1030 is created where at least one data track is not written or magnetic interference between data tracks written in both direction exists. Region 1030 is preferably bounded by guard bands respectively defined between lines 1030, 1040 and 1030, 1050. A reserved zone is defined between lines 1040 and 1050 that separates ID and OD written regions. Alternatively, the reserved zone can be defined only as region 1030. In addition, the width of this reserved zone can be based upon the servo track writer's run out or other criterion, such as the effect of PES from non-uniform servo patterns.

When writing the servo information from the OD to the MD, data track address information is incrementally written as typically done. When information from the ID to MD is written, the data track addresses are preferably decremented starting at a nominal data track address plus an offset. The nominal data track address is the nominal number of data tracks per the written disc surface. The offset is added to reduce the chance of having two data tracks with the same physical address. Under this method, when a disc drive is undergoing a certification process, the sector defect management will map the physical addresses to the logical addresses without encountering redundant physical data track addresses.

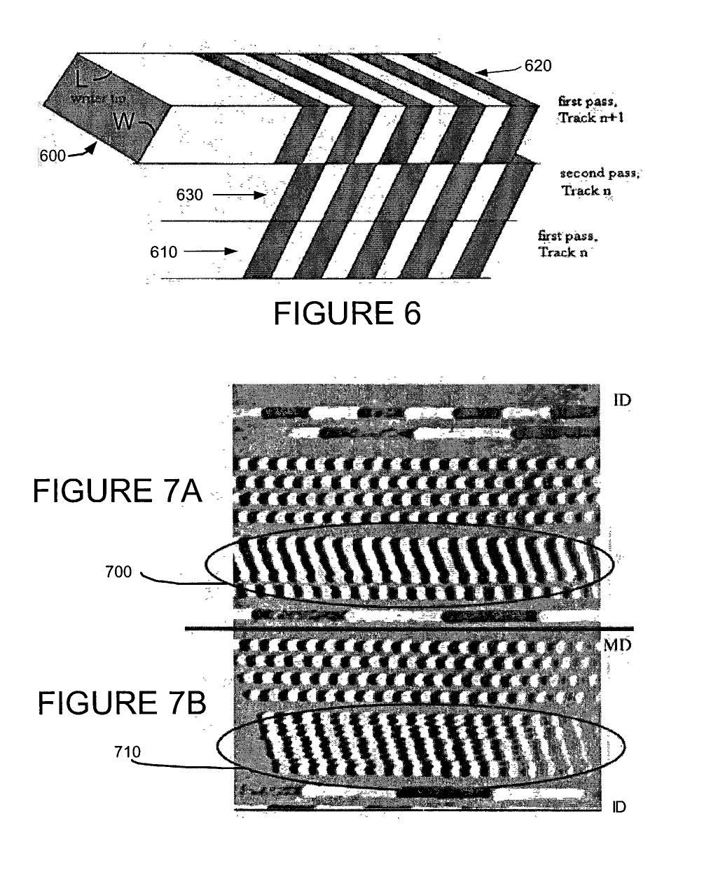

As discussed above, one method of the present invention writes servo information from the OD to the MD as shown partly in FIG. 4. Then, servo information is written from the ID to the MD. Referring to FIG. 6, a writer tip 600 is skewed similarly to writer tip 400 shown in FIG. 4. Writer tip 600 uses a leading edge W to write magnetic transitions 610 during a first pass of servo writing for data track n. Although not shown in FIG. 6, sidewall edge L also writes magnetic transitions relative to magnetic transitions 610 during that same pass that are similar to sidewall magnetic transitions 620. Upon the second pass of servo writing for data track n, the leading edge W writes magnetic transitions 630, that overwrite with the previous written sidewall magnetic transitions of the first pass. Likewise, the first pass of the servo writing for data track n+1 overwrites the previously written sidewall magnetic transitions of the second pass for data track n. Thus, undesired transition bands are minimized, if not altogether eliminated.

MFM images of a servo sector written with a perpendicular head on a perpendicular disc at −10 degree skew angle show the effectiveness of the present invention. FIG. 7A clearly shows that STW from ID to MD provides better stitching between passes for each servo pattern (shown by 700) compared to the servo pattern written from MD to ID shown in FIG. 7B by 710. As shown by the jagged edges in FIG. 7B, erasure occurs in the middle of servo tracks when servo tracks are written from MD to ID.

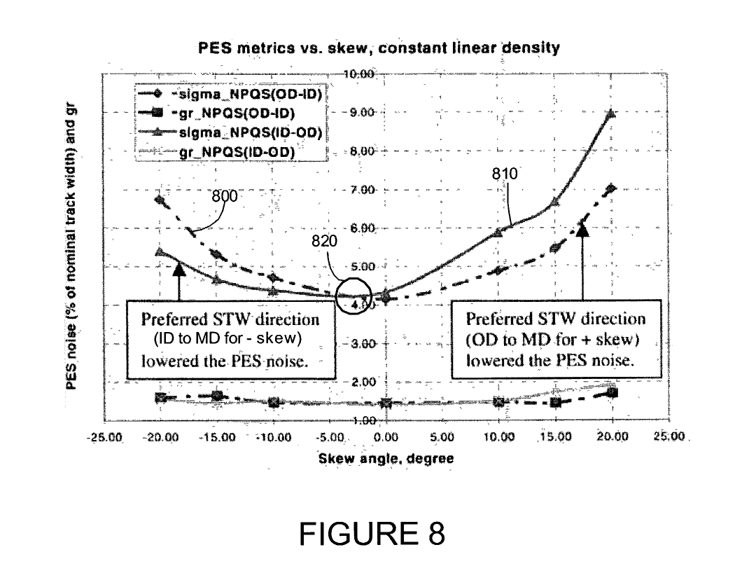

Servo position error signal (PES) data was collected on the servo pattern written bi-directionally according to the present invention. Two PES performance measures, PES noise as a percentage of nominal data track width and gain ratio, are shown in FIG. 8. Other PES metrics can be used, and the present invention is not limited by those shown in FIG. 8. As shown, the gain ratio does not significantly degrade with skew angle no matter which STW direction is. However, PES noise does decrease when servo tracks are written in preferred directions for both positive and negative skew according to the present invention. A solid line 810 in FIG. 8 results from writing servo information form the ID to the OD and a dashed line 800 results from writing servo information form the OD to the ID. Note that FIG. 8 shows the intersection of the two lines at an intersection area 820, which is shown to occur where the head has a negative skew angle. The location of the reserved zone may correspond to this intersection area. FIG. 8 supports that the servo information written bi-directionally will reduce PES noise. In a further embodiment of the present invention, the writing of the servo information can be done up to the MD without crossing. In this way data track interference can be minimized. The reserved zone, which may or may not include at least one guard band, is then defined between the data tracks where the servo information writing ended.

A guard band can be used for data track seeks. For example, an actuator may have a position that is in one zone and the desired data track to be sought is the data track immediately adjacent to the reserved zone, but the reserved zone must be traversed. Data track identification information in at least one data track in the guard zone adjacent the desired data track can be used by the servo system to position the actuator over the desired data track. In other words, any data track in the guard band can be used for providing servo information, other kinds of information or data. Preferably, the data does not include user data.

In current drive systems, as a servo track writer writes sequential data tracks from OD to ID, data track identification numbers are continuous integers starting from 1. When the servo track writer starts to write servo tracks from the ID toward the MD, it can be difficult to determine which data track identification number to start with relative to the data tracks that were written OD to MD. Another embodiment of the present invention writes from the OD to the ID first to estimate how many data tracks can be put on the disc surface, then re-write the negative skew region from ID to MD with known data track identification numbers. Another embodiment divides the entire disc surface into 2 zones: one is OD zone, the other is ID zone. An MSB bit can be allocated to data track the identification field to represent the zone number, for example, 0 as OD zone and 1 as ID zone. Then data tracks can be written from OD to MD first starting from OD zone data track 1 until reaching the reserved zone. Finally data tracks can be written from the ID to the MD starting from the ID zone data track 1. For example, if the current data track identification field has 16 bits, then the new data track identification field will have 17 bits. OD zone data track 1 will have data track identification 0×0000 and ID zone data track 1 will have data track ID 0×10001. A further embodiment encompasses writing servo track information from the ID to about the MD, then from the OD to about the MD.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts and values for the described variables, within the principles of the present invention to the full extent indicated by the broad general meaning of the terms in which the appended claims are expressed. For example, the particular elements may vary depending on the particular application for the servo system while maintaining substantially the same functionality without departing from the scope and spirit of the present invention. Although the present invention is preferably applied to perpendicular recording applications, it is also applicable to longitudinal recording applications.

In addition, although the preferred embodiment described herein is directed to servo track writing for a disc drive system, it will be appreciated by those skilled in the art that the teachings of the present invention can be applied to other systems, without departing from the scope and spirit of the present invention. The disc drive can be based upon magnetic, optical, or other storage technologies and may or may not employ a flying slider.

What is claimed is:

1. A method of writing servo information to a disc comprising the step of writing the servo information bi-directionally.

2. The method of claim 1 where the writing step includes writing servo information from an outer diameter of the disc to approximately a middle diameter and from an inner diameter to approximately the middle diameter.

3. The method of claim 1 where writing the servo information creates a reserved zone.

4. The method of claim 1 wherein the middle diameter is about where a head skew transitions from a positive to a negative skew.

5. The method of claim 2 further comprising the steps of:
writing the servo information from an outer diameter past the middle diameter; and
writing the servo information from the inner diameter past the middle diameter.

6. The method of claim 2 where the outer diameter to the middle diameter defines a first zone and the inner diameter to the middle diameter define a second zone.

7. The method of claim 6 wherein the servo information includes identification numbers that are associated to the zone that the servo information is written.

8. A method of writing servo information to a disc comprising the steps of:
writing servo information from an outer diameter to about a predetermined diameter; and
writing servo information from an inner diameter to about a the predetermined diameter.

9. The method of claim 8 where writing the servo information defines a reserved zone.

10. The method of claim 8 where the step of writing information from the outer diameter to the predetermined diameter includes writing servo information up to the predetermined diameter; and the step of writing servo information form the inner diameter to the predetermined diameter includes writing servo information up to the predetermined diameter.

11. The method of claim 8 where the outer diameter to the middle diameter defines a first zone and the inner diameter to the middle diameter define a second zone.

12. The method of claim 11 wherein the servo information includes identification numbers that are associated to the zone that the servo information is written.

13. An apparatus comprising a disc that has servo information stored thereon, where the servo information is written bi-directionally.

14. The apparatus of claim 13 wherein the bi-directionally written servo information has reduced sidewall magnetic transition interference.

15. The apparatus of claim 13 wherein the disc has a reserved zone.

16. The apparatus of claim 15 wherein the reserved zone includes at least one guard band.

17. The apparatus of claim 15 wherein the reserved zone divides the disc into two zones.

18. The apparatus of claim 17 wherein the two zones each include an associated identifier.
